(19) United States
(12) Patent Application Publication
(10) Pub. No.: US 2026/0300917 A1
(43) Pub. Date: Oct. 1, 2026

(54) SYSTEMS AND METHODS FOR GENERATING INFORMATION USING A MACHINE LEARNING SYSTEM

(71) Applicant: Capital One Services, LLC, McLean, VA (US)

(72) Inventors: David Adam PRESTON, Manakin Sabot, VA (US); John HENNEBERGER, Glen Allen, VA (US); Sankarraj LAKSHMANAN, Clarksburg, MD (US); Rahul BOBBASANI, Lake Zurich, IL (US); Mukund SUNDARARAJAN, Monroe, NJ (US)

(73) Assignee: Capital One Services, LLC, McLean, VA (US)

(21) Appl. No.: 19/093,938

(22) Filed: Mar. 28, 2025

(51) Int. Cl. G06Q 10/10; G06Q 30/018

(52) U.S. Cl. CPC G06Q 10/10; G06Q 30/018

(57) ABSTRACT

A method may include determining, using a first sub-model of a first machine learning (“ML”) model, one or more internal requirements (“IRs”) based on external requirement(s). The method may include generating, using a second sub-model of the first ML model, first information representing one or more differences between the one or more IRs and one or more previous IRs. The method may include generating, using a second ML model, second information representing updates to be made to first code. The method may include generating, using a third ML model, third information based on existing data, the third information representing, for one or more terms of the one or more IRs, an association between each of the one or more terms and a respective dataset. The method may include generating, using a fourth ML model, updated first code based on the first information, the second information, and the third information.

### TECHNICAL FIELD

Various embodiments of this disclosure relate generally to techniques for generating information using a machine learning system and, more particularly, to systems and methods for generating information (e.g., report(s), document(s), file(s), or the like) that conform with one or more requirements, using a multi-agent system.

### BACKGROUND

Many organizations are subject to controls such as laws, regulations, policies, or rules that require the organizations to generate information that comply with the controls, and to supply the information to one or more entities that are external or internal to the organizations. For example, a company may be required to prepare a report that complies with a regulation (e.g., a first regulation), and to supply the report to a regulator. However, in order to prepare and supply the report, the company may need to expend significant resources. That is, the company's employees may need to review the regulation, understand how the regulation applies to the company, identify a dataset needed to comply with the regulation, update tools (e.g., software applications or electronic documents) to generate or help draft the report, and provide the report to the regulator. Moreover, the regulation may be subject to change. As a result, the company may need to expend additional resources to review the changed regulation, understand how the changed regulation applies to the company, identify a new dataset needed to comply with the changed regulation, update tools to generate or help draft a new (or modified) report, and supply the new (or modified) report to the regulator. In some cases, the process for preparing the reports that comply with the first regulation and the changed regulation may be largely manual, and it may take the company's employees weeks, months, or even years to complete. Accordingly, the process for preparing and supplying the reports may be time-consuming, error-prone, subject to human bias, and expensive due to payroll costs or other costs.

This disclosure is directed to addressing one or more of the above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, systems and methods for generating information (e.g., report(s), document(s), file(s), or the like) that conform with one or more requirements, using a multi-agent system, are disclosed. Each of the examples disclosed herein may include one or more features described in connection with any of the other disclosed examples.

In one aspect, an exemplary embodiment of a method may include determining, using a first sub-model of a first machine learning model of a machine learning system, one or more internal requirements based on one or more external requirements. The method may also include generating, using a second sub-model of the first machine learning model, first information representing one or more differences between the one or more internal requirements and one or more previous internal requirements. The method may also include generating, using a second machine learning model of the machine learning system, second information representing updates to be made to first code based on the first code and the one or more internal requirements. The method may also include generating, using a third machine learning model of the machine learning system, third information based on existing data and the one or more internal requirements, the third information representing, for one or more terms of the one or more internal requirements, an association between each of the one or more terms and a respective dataset, the respective dataset including at least one of a portion of the existing data or an identification of new data. The method may also include generating, using a fourth machine learning model of the machine learning system, updated first code based on the first information, the second information, and the third information.

In another aspect, an exemplary embodiment of a computer system may include a processor and a memory having programming instructions stored thereon, which, when executed by the processor, cause the computing system to perform operations. The operations may include determining, using a first sub-model of a first large language model (LLM) agent of an artificial intelligence system, one or more internal requirements based on one or more external requirements. The operations may include generating, using a second sub-model of the first LLM agent, first information representing one or more differences between the one or more internal requirements and one or more previous internal requirements. The operations may include generating, using a second LLM agent of the artificial intelligence system, second information representing updates to be made to first code based on the first code and the one or more internal requirements. The operations may include generating, using a third LLM agent of the artificial intelligence system, third information based on existing data and the one or more internal requirements, the third information representing, for one or more terms of the one or more internal requirements, an association between each of the one or more terms and a respective dataset, the respective dataset including at least one of a portion of the existing data or an identification of new data. The operations may include generating, using a fourth LLM agent of the artificial intelligence system, updated first code based on the first information, the second information, and the third information.

In a further aspect, an exemplary embodiment of a method may include determining, using a first sub-model of a first machine learning model, one or more internal requirements based on one or more external requirements. The method may include generating, using a second sub-model of the first machine learning model, first information representing one or more differences between the one or more internal requirements and one or more previous internal requirements. The method may include generating, using a second machine learning model, second information representing updates to be made to first code based on the first code and the one or more internal requirements. The method may include generating, using a third machine learning model, third information based on existing data and the one or more internal requirements, the third information representing, for one or more terms of the one or more internal requirements, an association between each of the one or more terms and a respective dataset, the respective dataset including at least one of a portion of the existing data or an identification of new data. The method may include generating, using a fourth machine learning model, updated first code based on the first information, the second information, and the third information.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an example environment, according to one or more embodiments.

FIG. 2A illustrates an operation of multiple agents, according to one or more embodiments.

FIG. 2B illustrates an operation of a multi-agent system, according to one or more embodiments.

FIG. 3 illustrates an operation performed by an organization computing system, according to one or more embodiments.

FIG. 4 illustrates an operation for training and validating a model, according to one or more embodiments.

FIG. 5 illustrates a flowchart of an example method for generating information using a machine learning system, according to one or more embodiments.

FIG. 6 illustrates a flow diagram for training a machine learning model, according to one or more embodiments.

FIG. 7 depicts an example computing device, according to one or more embodiments.

### DETAILED DESCRIPTION OF EMBODIMENTS

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially,” “approximately,” “about,” and “generally,” are used to indicate a possible variation of ±10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

In the following description, embodiments will be described with reference to the accompanying drawings. As will be discussed in more detail below, various embodiments, systems, and methods for generating information (e.g., report(s), document(s), file(s), or the like) that conform with one or more requirements, using a multi-agent system, are described.

In an exemplary use case, an organization may be subject to a set of regulations (or requirements) issued by a regulatory agency. The organization may be a company in the finance, energy, transportation, manufacturing, telecommunications, environmental, real estate, agricultural, educational, or other industry. The set of regulations may require that the organization produce a report that discloses, for example, specific financial information associated with the organization, or evidence of how one or more processes practiced by (or products or services provided by) the organization meet certain standards. The report may include one or more of text, images, audio, or video. The set of regulations may also require that the organization supply the report to the regulatory agency.

In some embodiments, the organization may use an organization computing system configured to continuously monitor for new regulations electronically issued by a computing system (or entity system) associated with the regulatory agency. The organization computing system may electronically receive the set of regulations from the computing system associated with the regulatory agency. Upon receiving the set of regulations, the organization computing system may analyze the set of regulations using a multi-agent system. The multi-agent system may include, for example, a first large language model (“LLM”) agent, a second LLM agent, a third LLM agent, and a fourth LLM agent, where each of these LLM agents is configured to communicate with one another. The first LLM agent may receive, as input, the set of regulations, and output a set of new internal requirements based on the set of regulations. In some aspects, the set of new internal requirements may represent a version of the set of regulations that is specific (or applicable) to the organization. The first LLM agent may also receive, as input, a set of existing internal requirements that are specific to the organization, and the first LLM agent may output a comparison of the set of existing internal requirements to the set of new internal requirements.

The second LLM agent may receive, as input, existing code of the organization and the comparison (output by the first LLM agent). The second LLM agent may output information representing how the existing code should be updated so that when the updated, existing code is executed, a report may be produced that complies with the set of regulations (and the set of new internal requirements).

The third LLM may receive, as input, existing data of the organization and the set of new internal requirements (output by the first LLM agent). The third LLM may output information representing exactly what data (e.g., of the existing data or new data) is needed to satisfy the set of new internal requirements.

The fourth LLM may receive, as input, the comparison (and optionally the set of new internal requirements) from the first LLM, the information representing how the existing code should be updated from the second LLM, and the information representing exactly what data is needed to satisfy the set of new internal requirements from the third LLM. The fourth LLM may subsequently output updated code based on the received input. In some embodiments, the updated code may be reviewed or validated by an employee of the organization, and after the validation, the updated code may be executed by the organization computing system to produce the report. In some embodiments, the report may be validated by the employee or other individuals associated with the organization. After the report is validated, the organization computing system may transmit the report to the regulatory agency to comply with the set of regulations.

Conventional techniques for providing information (e.g., one or more reports, documents or files) to a regulatory agency in order to comply with a set of regulations are often highly labor intensive, time consuming, error prone, expensive, and subject to human bias. However, aspects of the present disclosure provide end-to-end systems and methods for providing such information in a significantly more efficient, accurate, and cost-effective manner that involves little or no bias. Further, techniques disclosed herein are configured to provide the information in an automatic, or largely automatic, manner.

While the example above involves a set of regulations and a regulatory agency, it should be understood that the systems and methods of this disclosure may be adapted to any suitable type of requirement (or control, law, policy, rule, or the like) and entity that issues or enforces such a requirement (or control, law, policy, rule, or the like). The entity may be external or internal to the organization. It should also be understood that the example above is illustrative only. The techniques and technologies of this disclosure may be adapted to any suitable activity.

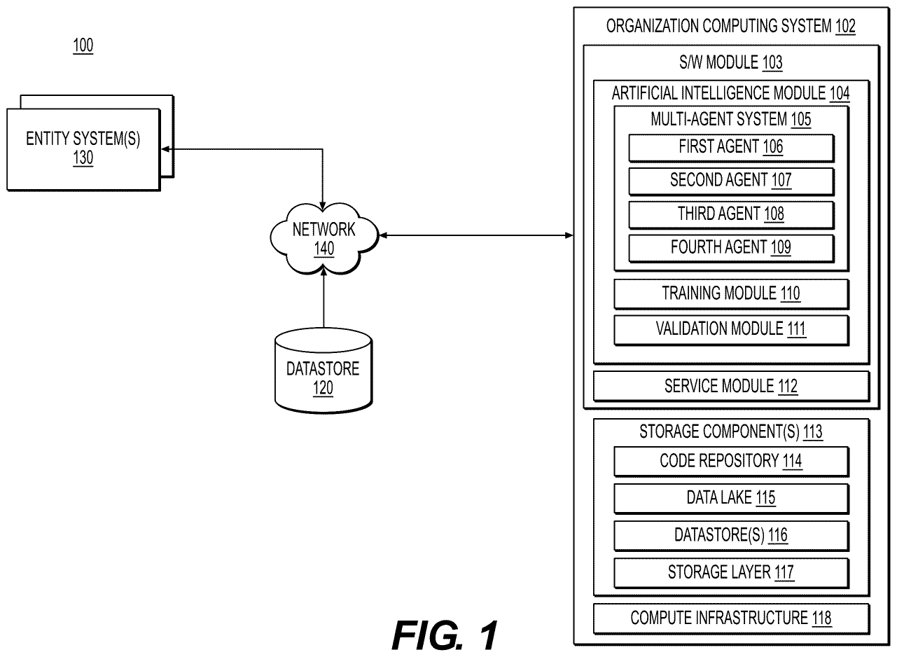

FIG. 1 depicts an example environment 100 that may be utilized with techniques presented herein. As shown in FIG. 1, the example environment 100 may include one or more of an organization computing system 102, entity system(s) 130, a datastore 120, and an electronic network 140. In some aspects, the organization computing system 102, the entity system(s) 130 (also referred to herein as the “entity system 130”), and the datastore 120 may communicate with one another in any arrangement, across the electronic network 140.

The organization computing system 102 may be a computer system such as a server, a workstation, a desktop computer, a laptop, a mobile device, a tablet, etc. In some examples, the organization computing system 102 may be associated with (or include) a cloud computing platform with scalable resources for computation or data storage. The organization computing system 102 may run one or more applications locally or using the cloud computing platform, to perform various computer-implemented methods described in this disclosure. In some embodiments, the organization computing system 102 may be associated with (e.g., owned, rented, controlled, or used by) an organization such as a company, business, merchant, non-profit, or the like. Further, in some embodiments, the organization computing system 102 may be configured to perform methods described in this disclosure. As shown in FIG. 1, the organization computing system 102 may include one or more of a software module 103 (also referred to herein as a “S/W module 103”), storage component(s) 113 (also referred to herein as the “storage component 113”), and a compute infrastructure 118. In some embodiments, the organization computing system 102 may be configured to receive (or retrieve, monitor for, or continuously monitor for) one or more controls, laws, regulations, policies, rules, requirements or the like (also referred to herein as “external requirements”) from the entity system 130, generate information that conform with the one or more requirements, and transmit (or send or supply) the generated information to the entity system 130 (or another entity). In some aspects, the information may represent one or more reports, documents, files, or the like, that contain one or more of text data, image data, audio data, or video data.

In some embodiments, the software module 103 may include an artificial intelligence (AI) module 104 (also referred to herein as the “AI module 104”) and a service module 112. The AI module 104 may be configured to train, validate, and deploy one or more AI models (e.g., machine learning models, large language models (“LLMs”), agents, LLM agents, or the like). As shown in FIG. 1, the AI module 104 may include a multi-agent system 105. In some embodiments, the multi-agent system 105 may include a first agent 106, a second agent 107, a third agent 108, and a fourth agent 109. In some aspects, each of the first agent 106, the second agent 107, the third agent 108, and the fourth agent 109 may be associated with or include an LLM. In some embodiments, the multi-agent system 105 may represent a single LLM that includes the first agent 106, the second agent 107, the third agent 108, and the fourth agent 109, where each of the first agent 106, the second agent 107, the third agent 108, and the fourth agent 109 represents, for example, a sub-LLM, a sub-model, a sub-agent, or the like.

The first agent 106 may be configured to receive one or more external requirements from the entity system 130. The first agent 106 may also be configured to receive (or to be trained using) one or more existing (e.g., current or legacy) internal requirements from the storage component 113, for example. In some aspects, the one or more existing internal requirements may represent one or more existing requirements that are specific to the organization associated with the organization computing system 102. For example, the one or more existing internal requirements may represent one or more organization requirements or business requirements.

In some embodiments, the first agent 106 include a first sub-agent (or first sub-model) configured to receive, as input, the one or more external requirements, and to output one or more new internal requirements based on the one or more external requirements. The one or more new internal requirements may represent a version of the one or more external requirements that is applicable to (or specific or tailored to) the organization associated with organization computing system 102. In some aspects, where the organization associated with the organization computing system 102 satisfies the one or more new internal requirements (e.g., as determined by the organization, an entity associated with the entity system 130, or another entity), the organization may be deemed to satisfy the one or more external requirements.

In some embodiments, the first agent 106 may also include an additional sub-agent (or additional sub-model) configured to receive, as input, the one or more existing internal requirements and the one or more new internal requirements. The additional sub-agent may also be configured to output a comparison of the one or more existing internal requirements to the one or more new internal requirements (also referred to herein as the “comparison”) based on the input. In some embodiments, the comparison may represent (e.g., as text or within a text document), differences between the one or more existing internal requirements and the one or more new requirements.

In some aspects, the first agent 106 may be configured to communicate with one or more of the second agent 107, the third agent 108, or the fourth agent 109. For example, the first agent 106 may be configured to output (or transmit) one or more of the comparison or the one or more new internal requirements to the second agent 107. The first agent 106 may also be configured to output (or transmit) the comparison and optionally the one or more new internal requirements to the fourth agent 109.

The second agent 107 may be configured to receive, as input, one or more of the comparison or the one or more new internal requirements, from the first agent 106. The second agent 107 may also be configured to receive, as input, existing code from the storage component 113 (e.g., the code repository 114) and optionally existing data (e.g., data, metadata, schema metadata, one or more datasets, text data, numerical data, or the like) from the storage component 113 (e.g., a data lake 115 or datastore(s) 116). In some aspects, the existing code may represent current or legacy instructions written in a programming language. The second agent 107 may be configured to output a code translation based on the existing code and one or more of (i) the comparison, (ii) the one or more new internal requirements, or (iii) the existing data. As used herein, a “code translation” may refer to information (e.g., a description) representing how the existing code should be updated such that when the updated code is executed (e.g., by the compute infrastructure 118), the updated code causes information to be produced that complies with the one or more new internal requirements (or one or more external requirements). In some aspects, the second agent 107 may be configured to communicate with one or more of the first agent 106, the third agent 108, or the fourth agent 109. For example, the second agent 107 may be configured to output the code translation to the fourth agent 109.

In some embodiments, the second agent 107 (or the software module 103, the storage component 113, or the compute infrastructure 118) may be configured to analyze schema metadata from the storage component 113 to determine exactly what data from the storage component 113 may be input (e.g., optionally) to the second agent 107 to produce the code translation 207. Further, in some embodiments, the second agent 107 (or the software module 103, the compute infrastructure 118, an LLM, or an LLM agent) may be configured to classify data of the storage component 113 (e.g., the data lake 115, where the data lake 115 may receive and store data, such as financial data, from one or more of the code repository 114, the datastore(s) 116, the storage layer 117, or the datastore 120, or other sources of the storage component 113). For example, the second agent 107 may be configured to classify data of the storage component 113 as relevant (or needed) to output the code translation 207. The second agent 107 may also be configured to receive such classified data as input, in order to output the code translation 207. Further, in some embodiments, the second agent 107 (or the software module 103, the compute infrastructure 118, an LLM, or an LLM agent) may be configured to output a recommendation regarding what data (e.g., of the storage component 113 or new data) is relevant (or needed) to output the code translation 207 (e.g., in response to the first agent 106 receiving external requirement(s) 202). In some embodiments, the second agent 107 may output the recommendation to the storage component 113, which may identify and transmit the data indicated in the recommendation to the second agent 107 for processing. Further, in some embodiments, the second agent 107 (or the software module 103, the compute infrastructure 118, an LLM, or an LLM agent) may be configured to receive data from the storage component 113, and determine data that is missing from the received data but needed to output the code translation 207. The second agent 107 (or the software module 103, the compute infrastructure 118, an LLM, or an LLM agent) may further be configured to transmit the determination to the storage component 113 (e.g., the data lake 115), and the storage component 113 may use the determination to improve future determinations regarding data to transmit to the second agent 107. Moreover, in some embodiments, the second agent 107 (or the software module 103, the compute infrastructure 118, an LLM, or an LLM agent) may use the determination as training data (or feedback), to improve classifications that the second agent 107 (or the software module 103, the compute infrastructure 118, an LLM, or an LLM agent) performs in the future, or recommendations that the second agent 107 (or the software module 103, the compute infrastructure 118, an LLM, or an LLM agent) outputs in the future.

In some aspects, similar to the second agent 107, the first agent 106 (or the software module 103, the compute infrastructure 118, an LLM, or an LLM agent) may be configured to classify data of the storage component 113 (e.g., the data lake 115, where the data lake 115 may receive and store data, such as financial data, from one or more of the code repository 114, the datastore(s) 116, the storage layer 117, or the datastore 120, or other sources of the storage component 113). For example, the first agent 106 may be configured to classify data of the storage component 113 as relevant (or needed) to output the new internal requirement(s) 204 or the comparison 205. Further, the first agent 106 (or the software module 103, the compute infrastructure 118, an LLM, or an LLM agent) may be configured to output a recommendation regarding what data (e.g., of the storage component 113 or new data) is relevant (or needed) to output the new internal requirement(s) 204 or the comparison 205 (e.g., in response to the first agent 106 receiving external requirement(s) 202). Further, in some embodiments, the first agent 106 (or the software module 103, the compute infrastructure 118, an LLM, or an LLM agent) may be configured to receive data from the storage component 113, and determine data that is missing from the received data but needed to output the new internal requirement(s) 204 or the comparison 205. The first agent 106 (or the software module 103, the compute infrastructure 118, an LLM, or an LLM agent) may further be configured to transmit the determination to the storage component 113 (e.g., the data lake 115), and the storage component 113 may use the determination to improve future determinations regarding data to transmit to the first agent 106. Moreover, in some embodiments, the first agent 106 (or the software module 103, the compute infrastructure 118, an LLM, or an LLM agent) may use the determination as training data (or feedback), to improve classifications that the first agent 106 (or the software module 103, the compute infrastructure 118, an LLM, or an LLM agent) performs in the future, or recommendations that the first agent 106 (or the software module 103, the compute infrastructure 118, an LLM, or an LLM agent) outputs in the future.

The third agent 108 may be configured to receive, as input, existing data (e.g., data, metadata, scheme metadata, one or more datasets, text data, numerical data, or the like) from the storage component 113 (e.g., the data lake 115 or the datastore(s) 116). The third agent 108 may also be configured to receive (or may be trained using) the one or more new internal requirements from, for example, the first agent 106 or the second agent 107. In some aspects, the third agent 108 may be configured to output information representing a mapping (e.g., a correlation or association) based on the existing data and one or more new internal requirements. The mapping may represent what portion(s) of the existing data and optionally what new data is needed to satisfy the one or more new internal requirements. For example, where one of the one or more new internal requirements includes the term (or phrase), “total number of deposits for the last 12 months,” the mapping may indicate exactly what portion(s) of the data (and any new data that needs to be obtained or generated by the organization computing system 102) are needed to determine the total number of deposits for the last 12 months. In some aspects, the third agent 108 may be configured to communicate with one or more of the first agent 106, the second agent 107, or the fourth agent 109. For example, the third agent 108 may be configured to output the mapping to the fourth agent 109.

Further, in some embodiments, the third agent 108 (or the software module 103, the storage component 113, or the compute infrastructure 118) may be configured to analyze schema metadata from the storage component 113 to determine exactly what data from the storage component 113 is input to the third agent 108 or included in the mapping output by the third agent 108. Further, in some embodiments, the third agent 108 (or the software module 103, the compute infrastructure 118, an LLM, or an LLM agent) may be configured to classify data of the storage component 113 (e.g., the data lake 115, where the data lake may receive and store data, such as financial data, from one or more of the code repository 114, the datastore(s) 116, the storage layer 117, or the datastore 120, or other sources of the storage component 113). For example, the third agent 108 may be configured to classify data of the storage component 113 as relevant (or needed) to output the mapping 209. The third agent 108 may also be configured to receive such classified data as input, in order to output the mapping 209. Further, in some embodiments, the third agent 108 (or the software module 103, the compute infrastructure 118, an LLM, or an LLM agent) may be configured to output a recommendation regarding what data (e.g., of the storage component 113 or new data) is relevant (or needed) to output the mapping 209 (e.g., in response to the first agent 106 receiving external requirement(s) 202). In some embodiments, the third agent 108 may output the recommendation to the storage component 113, which may identify and transmit the data indicated in the recommendation to the third agent 108 for processing. Further, in some embodiments, the third agent 108 (or the software module 103, the compute infrastructure 118, an LLM, or an LLM agent) may be configured to receive data from the storage component 113, and determine data that is missing from the received data but needed to output the mapping 209. The third agent 108 (or the software module 103, the compute infrastructure 118, an LLM, or an LLM agent) may further be configured to transmit the determination to the storage component 113 (e.g., the data lake 115), and the storage component 113 may use the determination to improve future determinations regarding data to transmit to the third agent 108. Moreover, in some embodiments, the third agent 108 (or the software module 103, the compute infrastructure 118, an LLM, or an LLM agent) may use the determination as training data (or feedback), to improve classifications that the third agent 108 (or the software module 103, the compute infrastructure 118, an LLM, or an LLM agent) performs in the future, or recommendations that the third agent 108 (or the software module 103, the compute infrastructure 118, an LLM, or an LLM agent) outputs in the future.

In some embodiments, fourth agent 109 may be configured to receive, as input, the comparison (and optionally the one or more new internal requirements) from the first agent 106, the code translation from the second agent 107, the mapping from the third agent 108, and optionally text provided by a user (e.g., an employee of the organization associated with the organization computing system 102) via text-based prompts. Further, the fourth agent 109 may be configured to output updated code based on the received input. As explained above, the updated code may represent code that, when executed (e.g., by the compute infrastructure 118), causes information (e.g., one or more reports, documents, files, or the like) to be generated that complies with the one or more new internal requirements (or the one or more external requirements). In some embodiments the updated code may represent code written in SQL, Python, or another programming language. Further, the updated code, when executed, may be configured to transform or modify data retrieved from the storage component 113, and to perform one or more calculations, optionally using such data. In some aspects, the fourth agent 109 may be configured to communicate with one or more of the first agent 106, the second agent 107, the third agent 108, the service module 112, the storage component 113, or the compute infrastructure 118. For example, in some embodiments, the fourth agent 109 may output updated code to the code repository 114 for storage. In some aspects, the fourth agent 109 may be configured to perform classification, or to output recommendations, in a manner similar to that described above with respect to the first agent 106, the second agent 107, and the third agent 108.

The training module 110 may represent software or a platform configured to train the multi-agent system 105 (e.g., the first agent 106, the second agent 107, the third agent 108, and the fourth agent 109, or any machine learning models included or associated with the multi-agent system 105). In some aspects, the training module 110 may be configured to train the first agent 106 using one or more machine learning algorithms described herein, and by analyzing training data including, for example, one or more of (i) historical or simulated internal requirements (e.g., specific to the organization associated with the organization computing system 102 or another entity), (ii) historical or simulated external requirements (e.g., associated with the entity system 130 or another entity), (iii) historical or simulated internal requirements derived from the historical or simulated external requirements, or (iv) historical or simulated comparisons. The training module 110 may be configured to train the second agent 107 using one or more machine learning algorithms described herein, and by analyzing training data including, for example, one or more of (i) historical or simulated comparisons, (ii) historical or simulated internal requirements derived from historical or simulated external requirements, (iii) historical or simulated code, or (iv) historical or simulated data. The training module 110 may be configured to train the third agent 108 using one or more machine learning algorithms described herein, and by analyzing training data including, for example, one or more of (i) historical or simulated data, or (ii) historical or simulated internal requirements derived from historical or simulated external requirements. The training module 110 may be configured to train the fourth agent 109 using one or more machine learning algorithms described herein, and by analyzing training data including, for example, one or more of (i) historical or simulated comparisons, (ii) historical or simulated internal requirements derived from historical or simulated external requirements, (iii) historical or simulated code translations, (iv) historical or simulated mappings, (v) historical or simulated data (e.g., associated with the storage component 113), or (vi) historical or simulated text prompts. In some embodiments, the training module 110 may be configured to detect and remediate any errors or hallucinations generated during training of the multi-agent system 105.

The validation module 111 may be configured to communicate with the training module 110 and to validate (or determine the accuracy or precision of) one or more machine learning models trained by the training module 110. In some embodiments, the validation module 111 may be configured to validate updated code (e.g., as described with reference to validation 407, described further herein). In some embodiments, the validation module 111 may be configured to detect one or more errors or hallucinations included in the one or more machine learning models trained by the training module 110. The validation module 111 may further be configured to communicate the one or more errors or hallucinations to the training module 110 for remediation. While not shown in FIG. 1, in some embodiments, the validation module 111 may be included in the training module 110.

The service module 112 may be configured to communicate with one or more of the artificial intelligence module 104, the storage component 113, or the compute infrastructure 118. For example, in some embodiments, the service module 112 may be configured to retrieve updated code from the code repository 114 and transmit the retrieved, updated code to the compute infrastructure 118 for execution.

The storage component 113 may represent one or more of software, hardware, firmware, or protocols associated with storing, managing, or maintaining data and code. As shown in FIG. 1, the storage component 113 may include one or more of the code repository 114, the data lake 115, the datastore(s) 116, and a storage layer 117. In some embodiments, the code repository 114 may be configured to store any or all code (e.g., existing code or updated code) of the organization associated with the organization computing system 102. The data lake 115 may be configured to store any or all data (e.g., non-code, datasets, documents, reports, text data, quantitative data, audio data, or video data) of the organization associated with the organization computing system 102. In some embodiments, the data lake 115 may be configured to store raw data or data in a native format. The datastore(s) 116 may be configured to store and manage any or all data or code of the organization associated with the organization computing system 102. The storage layer 117 may represent software, hardware, and protocols configured to manage the storage and retrieval of data associated with the organization computing system 102. For example, the storage layer 117 may be configured to facilitate the efficient storage and retrieval of data.

In some aspects, some or all of the data (or metadata) of the storage component 113 may be formatted to facilitate the efficient execution of the multi-agent system 105 and the updated code. For example, in some embodiments, the data may include terminology (or nomenclature or names) that is consistent or standardized (e.g., across the storage component 113). As another example, each of one or more datasets of the storage component 113 may include or be associated with an accurate description of the content of a respective one of the one or more datasets. As another example, data of the storage component 113 may be stored in Comma-Separated-Values (CSV) format or another readable format. In some embodiments, data of the storage component 113 may represent tabular data (e.g., data organized in rows and columns). In such embodiments, terms or names included in or associated with the data may be spelled out in full (as opposed to being represented as an abbreviation or acronym); high-cardinality, categorical columns of a given dataset may be reduced; categorical values may be represented in lowercase text; dates may be consistently formatted; timestamps may be consistently formatted; column(s) may include or be associated with detailed descriptions of the column(s); rows may include or be associated with detailed descriptions of the row(s); the data may include terms expected to be found in report(s), document(s), files, or other information to be generated to comply with one or more new internal requirements (or one or more external requirements); the data may include terms previously found in report(s), document(s), files, or other information generated to comply with one or more existing internal requirements; a description of a dataset may include multiple different names for a given column of the dataset; or a dataset may include or be associated with a description of how additional information (e.g., a join condition) regarding a particular column of the dataset can be obtained from another dataset.

In some embodiments, the compute infrastructure 118 may represent one or more processors configured to execute updated code. In some aspects, the compute infrastructure 118 may be configured to communicate with the storage component 113 and the software module 103. For example, the compute infrastructure 118 may be configured to receive updated code, via the service module 112, from the code repository 114. As another example, the compute infrastructure 118 may be configured to receive (or retrieve), from the storage component 113, existing data or newly obtained or newly generated data to facilitate the execution of the updated code. As another example, the compute infrastructure 118 may be configured to receive (or retrieve) and analyze schema metadata from the storage component 113, and to use the analysis to determine exactly what other data (e.g., datasets) to receive (or retrieve) from the storage component 113 to execute the updated code. In some aspects, the compute infrastructure 118 may be configured to perform classification, or to output recommendations, in a manner similar to that described above with respect to the first agent 106, the second agent 107, and the third agent 108. Further, in some embodiments, the compute infrastructure 118 may be configured to output information (e.g., report(s), document(s), file(s), or the like) generated based on the updated code, to the entity system 130 or another entity.

The datastore 120 may represent a database configured to communicate with the organization computing system 102. In some aspects, the datastore 120 may include computer-readable memory such as a hard drive, flash drive, disk, etc. Further, the datastore 120 may be an embodiment of the storage component 113.

The entity system 130 may be a computer system such as a server, a workstation, a desktop computer, a laptop, a mobile device, a tablet, etc. In some examples, the entity system 130 may be associated with (or include) a cloud computing platform with scalable resources for computation or data storage. The entity system 130 may run one or more applications locally or using the cloud computing platform, to perform various computer-implemented methods described in this disclosure. In some embodiments, the entity system 130 may be associated with (e.g., owned, rented, controlled, or used by) an entity such as a regulatory body, a governmental body, or other entity that is external (or internal) to the organization associated with the organization computing system 102. In some aspects, the entity system 130 may be configured to generate or store one or more external requirements. The entity system 130 may also be configured to transmit or supply the one or more external requirements to the organization computing system 102 and optionally the datastore 120.

Although depicted as separate components in FIG. 1, it should be understood that a component or portion of a component in the environment 100 may, in some embodiments, be integrated with or incorporated into one or more other components. For example, the entity system 130 may be integrated into the organization computing system 102. As another example, the datastore 120 may be integrated into the organization computing system 102, as discussed above. In some embodiments, operations or aspects of one or more of the components discussed above may be distributed amongst one or more other components. Any suitable arrangement or integration of the various systems and devices of the environment 100 may be used.

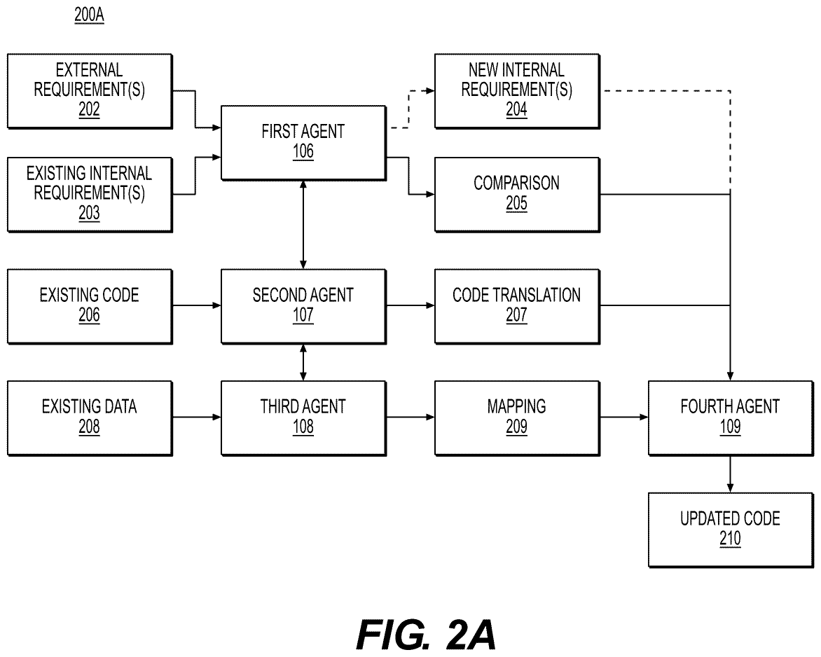

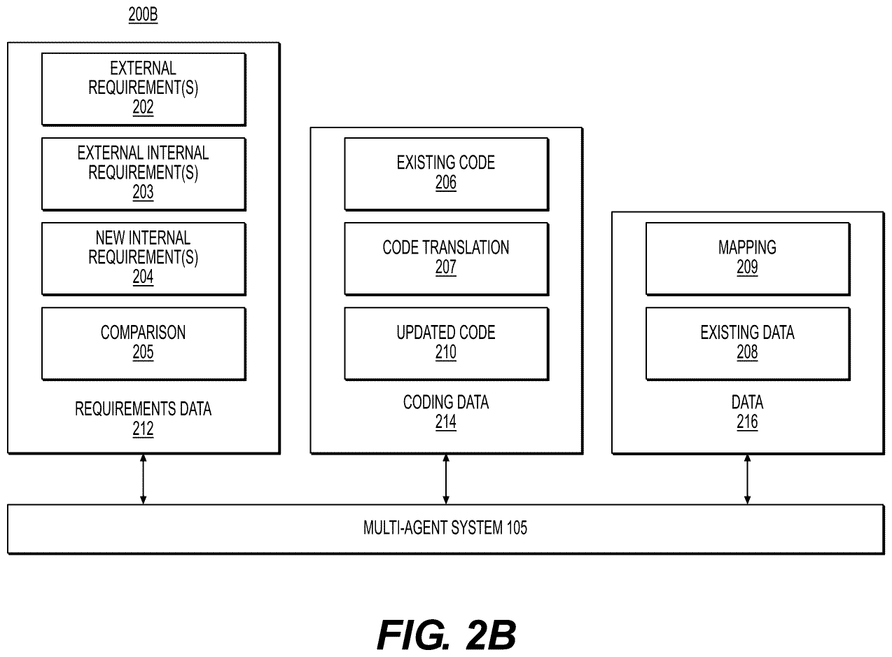

FIG. 2A illustrates an operation 200A of multiple agents (e.g., of the multi-agent system 105), according to one or more embodiments. As shown in FIG. 2A, the multiple agents include the first agent 106, the second agent 107, the third agent 108, and the fourth agent 109. During operation, the first agent 106 may receive, as input, external requirement(s) 202 (e.g., from the entity system 130) and existing internal requirement(s) 203 (e.g., from the storage component 113). The first agent 106 may include a first sub-agent that outputs new internal requirement(s) 204 based on the external requirement(s) 202. The first agent 106 may also include an additional sub-agent that receives, as input, existing internal requirement(s) 203 and the new internal requirement(s) 204 and outputs a comparison 205 based on the input. The comparison 205 may represent differences between the existing internal requirement(s) 203 and the new internal requirement(s) 204. In some embodiments, the first agent 106 may transmit one or more of the new internal requirement(s) 204 or the comparison 205 to the second agent 107. Further, the first agent 106 may transmit the comparison 205, and optionally the new internal requirement(s) 204, to the fourth agent 109.

Upon receiving, as input, one or more of the new internal requirement(s) 204 or the comparison 205, the second agent 107 may also receive, as input, existing code 206 (e.g., from the code repository 114) and optionally existing data 208 (e.g., from the storage component 113). The second agent 107 may output a code translation 207 based on the inputs. Further, the second agent 107 may output the code translation 207 to the fourth agent 109. In some embodiments, the second agent 107 may transmit the new internal requirement(s) 204 to the third agent 108.

The third agent 108 may receive, as input, the new internal requirement(s) 204 from the second agent 107 (or from the first agent 106). Upon receiving the new internal requirement(s) 204, the third agent 108 may receive existing data 208 (e.g., from the storage component 113). The third agent 108 may output a mapping 209 based on the inputs. The mapping 209 may represent what portion(s) of the existing data 208, and any new data, that are needed to satisfy the new internal requirement(s) 204. In some aspects, the third agent 108 may output the mapping 209 to the fourth agent 109.

The fourth agent 109, may receive, as input, the comparison 205, the code translation 207, the mapping 209, optionally the new internal requirement(s) 204, and optionally one or more text prompts (e.g., from a user of the organization computing system 102). The fourth agent may output updated code 210 based on the input. The updated code 210 may represent code that, when executed (e.g., by the compute infrastructure 118), produces information (e.g., one or more reports, documents, files, or the like) that complies with the new internal requirement(s) 204 (or the external requirement(s) 202).

FIG. 2B illustrates an operation 200B of the multi-agent system 105, according to one or more embodiments. In some aspects, the multi-agent system 105 may represent a single LLM agent that includes, as sub-agents, for example, the first agent 106, the second agent 107, the third agent 108, and the fourth agent 109. The operation 200B may be an embodiment of the operation 200A of FIG. 2A.

As shown in FIG. 2B, during operation, the multi-agent system 105 may receive, as input, or may output, various requirements data 212, coding data 214, and data 216. The requirements data 212 may include the external requirement(s) 202, the existing internal requirement(s) 203, the new internal requirement(s) 204, and the comparison 205. The coding data 214 may include the existing code 206, the code translation 207, and the updated code 210. The data 216 may include the mapping 209 and the existing data 208.

In some embodiments, the multi-agent system 105 may receive, as input, the external requirement(s) 202, and may output the new internal requirement(s) 204 based on the external requirement(s) 202. The multi-agent system 105 may also receive, as input, the existing internal requirement(s) 203, and output the comparison 205 based on the existing internal requirement(s) 203 and the new internal requirement(s) 204.

The multi-agent system 105 may receive, as input, the existing code 206 and optionally the existing data 208, and output the code translation 207 based on the existing code 206 and optionally one or more of (i) the new internal requirement(s) 204 (ii) the comparison 205, or (iii) the existing data 208.

The multi-agent system 105 may further receive, as input, the existing data 208, and output the mapping 209 based on the existing data 208 and the new internal requirement(s) 204. The multi-agent system 105 may also receive, as input, the mapping 209, the code translation 207, the comparison 205, optionally the new internal requirement(s) 204, and optionally one or more text prompts, and output the updated code 210 based on the input.

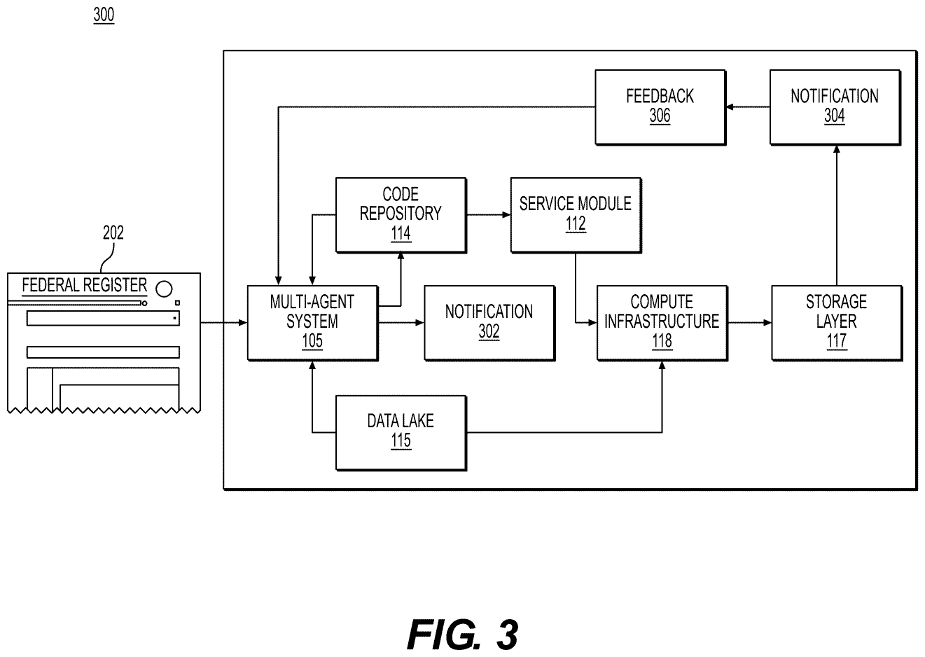

FIG. 3 illustrates an operation 300 performed by the organization computing system 102, according to one or more embodiments. As shown in FIG. 3, the multi-agent system 105 may receive external requirement(s) 202 (e.g., from the entity system 130). The multi-agent system 105 may further receive existing data (including existing internal requirements) from the data lake 115 (or the datastore(s) 116) and existing code from the code repository 114. The multi-agent system 105 may output updated code based on the external requirement(s), the existing data (including the existing internal requirements), the existing code, and optionally one or more text prompts. In some embodiments, the multi-agent system 105 may output the updated code to the code repository 114. Further, the multi-agent system 105 may output a notification 302 for display on a display screen of the organization computing system 102. The notification 302 may be directed to a user of the organization computing system 102 (e.g., an employee of the organization associated with the organization computing system 102). Further, the notification 302 may instruct the user to validate (or determine the accuracy of) the updated code.

In some embodiments, once the updated code is validated, the service module 112 may receive (or retrieve) the updated code from the code repository 114 and transmit the updated code to the compute infrastructure 118. Upon receiving the updated code, the compute infrastructure 118 may execute the updated code, and during the execution, the compute infrastructure may retrieve data from the data lake 115 (or the datastore(s) 116). In some embodiments, data retrieved from the data lake 115 (or the datastore(s) 116) may include data that was newly obtained or newly generated to facilitate the execution of the updated code. Further, the compute infrastructure 118 may output information (e.g., one or more reports, documents, files, or the like) that complies with the new internal requirement(s) 204 (or the external requirement(s) 202). In some embodiments, the compute infrastructure 118 may output the information to the storage layer 117. Upon receiving the information, the storage layer 117 may cause a notification 304 to be displayed on the display screen of the organization computing system 102, where the notification 304 instructs the user to validate the information (e.g., determine whether the information is accurate or complies with the new internal requirement(s) 204 or the external requirement(s) 202). In some embodiments, the user may cause feedback 306 to be provided to the multi-agent system 105, where the feedback 306 may identify any discrepancies or errors detected in the information during validation. The multi-agent system 105 may receive the feedback 306 as input, or be re-trained based on the feedback 306, to subsequently provide updated code that may be executed to produce more accurate or compliant information (e.g., report(s), document(s), file(s), or the like). In some embodiments, the multi-agent system 105 may be configured to validate itself (e.g., a single LLM or a plurality of agents) by detecting and remediating any errors or hallucinations produced during deployment of the multi-agent system 105.

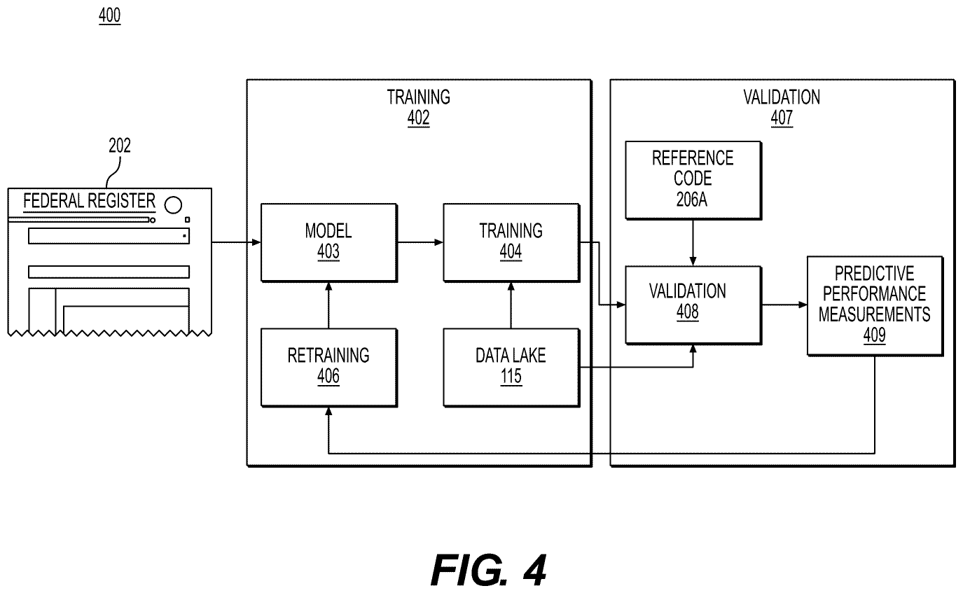

FIG. 4 depicts an operation 400 for training and validating a model 403 (e.g., a machine learning model such as an LLM, agent, LLM agent, generative machine learning model, or the like), according to one or more embodiments. As shown in FIG. 4, the operation 400 may include training 402 and validation 407. In some embodiments, the training 402 may be performed by the training module 110, and the validation 407 may be performed by the validation module 111. In some embodiments, the model 403 may be a single untrained model (e.g., an LLM) that, once fully trained, includes each of the first agent 106, the second agent 107, the third agent 108, and the fourth agent 109, as a respective sub-model, for example. In some other embodiments, the model 403 may be an untrained multi-agent system that, once fully trained, represents the multi-agent system 105 (e.g., including each of the first agent 106, the second agent 107, the third agent 108, and the fourth agent 109).

In some aspects, the operation 400 may begin with the training 402. That is, the model 403 may receive, as input, external requirement(s) 202 (e.g., from the entity system 130). The model 403 may subsequently undergo training 404, in which the model 403 may further receive existing data from the data lake 115 (or the datastore(s) 116), optionally along with existing code from the code repository 114 (not shown in FIG. 4), and the model 403 may then output updated code based on the received external requirement(s) 202, the existing data, and optionally the existing code.

Once the updated code is output, the validation 408 may begin. That is, the updated code may undergo validation 408 (e.g., by the validation module 111). In some embodiments, during the validation 407, the updated code may be executed to produce first information (e.g., report(s), document(s), file(s), or the like) that should satisfy the external requirement(s) 202. During execution of the updated code, existing data may be retrieved (e.g., by the validation module 111) from the data lake 115 (or the datastore(s) 116) and used to produce the first information. During the validation 408, the reference code 206A may also be executed (e.g., by the validation module 111) to produce second information (e.g., report(s), document(s), file(s), or the like) that do satisfy the external requirement(s) 202. The reference code 206A may be an embodiment of the existing code 206. In some aspects, one or more of the reference code 206A and second information may represent ground truth (e.g., a benchmark). The validation 408 may further include comparing one or more of (i) the first information to the second information, or (ii) the updated code to the existing code. In some embodiments, the validation 408 may include determining, based on the comparing, one or more of (i) differences between the first information and the second information, (ii) differences between the updated code and the existing code, or (iii) predictive performance measurements 409 based on (i) or (ii). In some aspects, the predictive performance measurements 409 may represent predictions regarding the accuracy of updated code to be output from the model 403 when the model 403 is deployed. Further, in some aspects, the predictive performance measurements 409 may represent how close or similar the first information is to the second information (or how close or similar the updated code is to the reference code 206A). In some embodiments, where the predictive performance measurements 409 indicate that the first information is not sufficiently similar to (or does not match) the second information (or that the updated code is not sufficiently similar to, or does not match, the reference code 206A), the training 402 may resume with retraining 406. During the retraining 406, the model 403 may be subject to the training 404 once again, but this time based on the predictive performance measurement 409 (or information regarding how the training 404 should be improved) so that the retrained model 403 outputs more accurate updated code. In some embodiments, the updated code output from the retrained model 403 may undergo validation 407, and the operation 400 may repeat iteratively until predictive performance measurements 409 are generated that indicate the retrained model 403 is fully trained (e.g., likely to output first information that is sufficiently accurate).

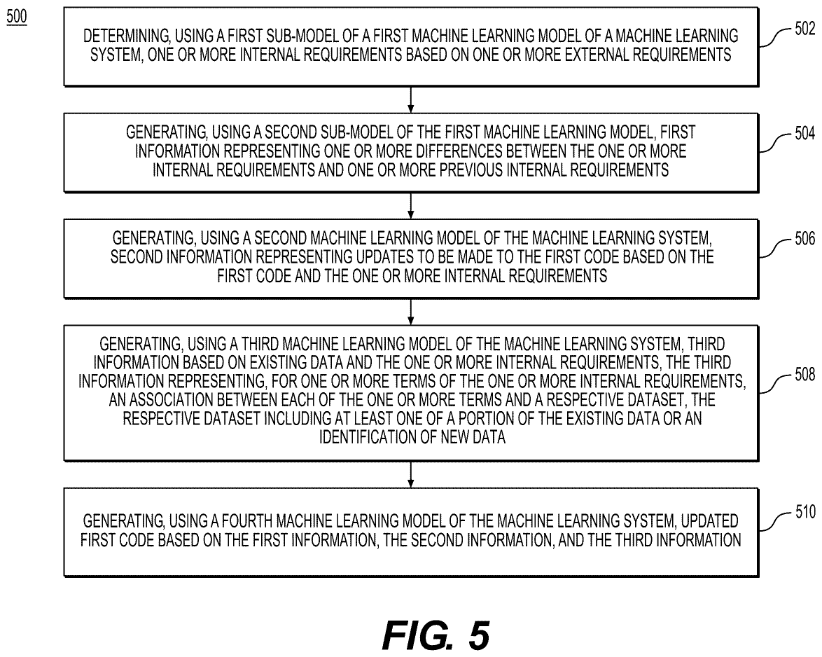

FIG. 5 is a flowchart illustrating a method 500 for generating information (e.g., one or more reports, documents, files or the like) using a machine learning system, in accordance with one or more embodiments. In some aspects, the method 500 may be performed by the organization computing system 102.

As shown in FIG. 5, the method 500 may include determining, using a first sub-model of a first machine learning model (e.g., the first agent 106) of a machine learning system (e.g., the multi-agent system 105), one or more internal requirements (e.g., the new internal requirement(s) 204) based on one or more external requirements (e.g., the external requirement(s) 202) (502). The method 500 may also include generating, using a second sub-model of the first machine learning model, first information (e.g., the comparison 205) representing one or more differences between the one or more internal requirements and one or more previous internal requirements (e.g., existing internal requirement(s) 203) (504). In some embodiments, the first information may be generated, using the second sub-model of the first machine learning model, based on comparing the one or more internal requirements to the one or more previous internal requirements. Further, in some embodiments, the first information may represent text data.

The method 500 may include generating, using a second machine learning model (e.g., the second agent 107) of the machine learning system, second information (e.g., the code translation 207) representing updates to be made to first code (e.g., the existing code 206) based on the first code and the one or more internal requirements (506).

The method 500 may include generating, using a third machine learning model (e.g., the third agent 108) of the machine learning system, third information (e.g., the mapping 209) based on existing data (e.g., the existing data 208) and the one or more internal requirements, the third information representing, for one or more terms of the one or more internal requirements, an association between each of the one or more terms and a respective dataset, the respective dataset including at least one of a portion of the existing data or an identification of new data (e.g., an identification of data that needs to be generated or obtained) (508). In some embodiments, the existing data may be standardized or include metadata. Further, in some embodiments, the method 500 may include generating or obtaining the new data (e.g., using the organization computing system 102).

The method 500 may include generating, using a fourth machine learning model (e.g., the fourth agent 109) of the machine learning system, updated first code (e.g., the updated code 210) based on the first information, the second information, and the third information (510). In some embodiments, the updated first code may be generated, using the fourth machine learning model of the machine learning system, further based on the new data. Further, in some embodiments, the method 500 may include generating, using the compute infrastructure 118, fourth information based on the updated first code. The fourth information may represent, for example, one or more reports, documents, files, or the like, that conform with the one or more internal requirements. In some embodiments, the fourth information may be generated based on one or more of the existing data or the new data.

In some embodiments, the method 500 may further include receiving, by the machine learning system, fifth information representing feedback (e.g., the feedback 306) associated with a test for validation of the fourth information. Further, in some embodiments, one or more of the first machine learning model, the second machine learning model, the third machine learning model, or the fourth machine learning model, may include a respective generative machine learning model. In some embodiments, the method 500 may include classifying, using the machine learning system, information as relevant to generating one or more of the updated first code or the fourth information, wherein one or more of the updated first code or the fourth information is generated based on the classified information. Further, in some embodiments, the method 500 may include outputting, using the machine learning system, recommended information, wherein the recommended information represents information needed to generate one or more of the updated first code or the fourth information. In some embodiments, the method 500 may include transmitting, by the machine learning system and to a storage component (e.g., the storage component(s) 113 or the data lake 115), an indication of missing information, wherein the indication of missing information represents information missing from the machine learning system and needed to generate one or more of the updated first code or the fourth information.

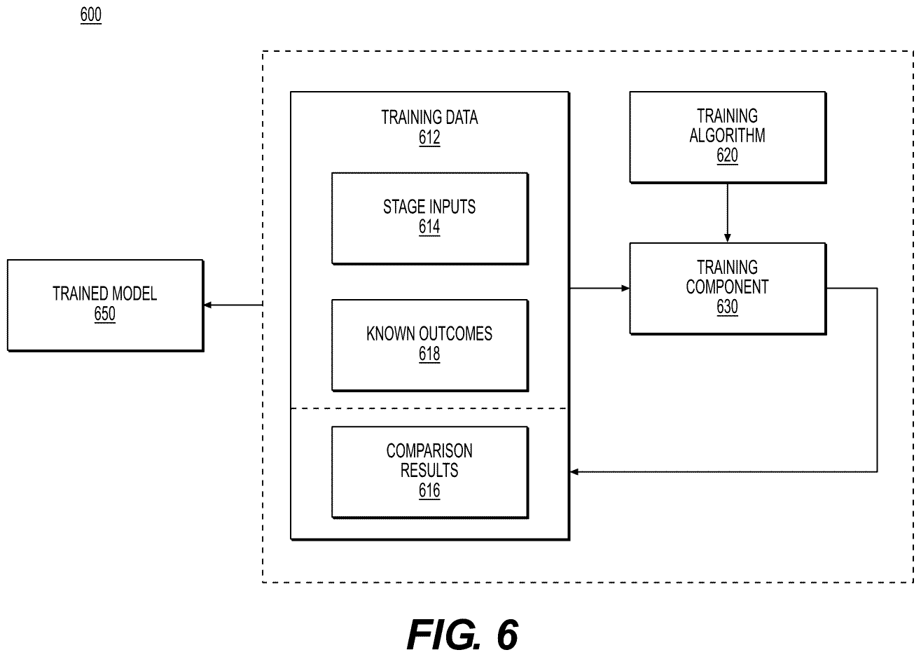

FIG. 6 depicts a flow diagram for training a machine learning model, in accordance with one or more embodiments. As shown in flow diagram 600 of FIG. 6, training data 612 may include one or more of stage inputs 614 and known outcomes 618 related to a machine learning model to be trained. The stage inputs 614 may be from any applicable source including a component or set shown in the figures provided herein. The known outcomes 618 may be included for machine learning models generated based on supervised or semi-supervised training. An unsupervised machine learning model might not be trained using known outcomes 618. Known outcomes 618 may include known or desired outputs for future inputs similar to or in the same category as stage inputs 614 that do not have corresponding known outputs.

The training data 612 and a training algorithm 620 may be provided to a training component 630 that may apply the training data 612 to the training algorithm 620 to generate a trained machine learning model 650. According to an implementation, the training component 630 may be provided comparison results 616 that compare a previous output of the corresponding machine learning model to apply the previous result to re-train the machine learning model. The comparison results 616 may be used by the training component 630 to update the corresponding machine learning model. The training algorithm 620 may utilize machine learning networks or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, or discriminative models such as Decision Forests and maximum margin methods, or the like. The output of the flow diagram 600 may be a trained machine learning model 650.

A machine learning model disclosed herein may be trained by adjusting one or more weights, layers, or biases during a training phase. During the training phase, historical or simulated data may be provided as inputs to the model. The model may adjust one or more of its weights, layers, or biases based on such historical or simulated information. The adjusted weights, layers, or biases may be configured in a production version of the machine learning model (e.g., a trained model) based on the training. Once trained, the machine learning model may output machine learning model outputs in accordance with the subject matter disclosed herein. According to an implementation, one or more machine learning models disclosed herein may continuously update based on feedback associated with use or implementation of the machine learning model outputs.

In general, any process or operation discussed in this disclosure that is understood to be computer-implementable, such as the processes or operations illustrated in FIGS. 2A-6, may be performed by one or more processors of a computer system or quantum computing system, such as any of the systems or devices in the environment 100 of FIG. 1, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system or quantum computing system. A processor may be a central processing unit (CPU), a graphics processing unit (GPU), a quantum processor, a quantum processing unit (QPU), or any suitable types of processing unit.

A computer system, such as a system or device implementing a process or operation in the examples above, may include one or more computing devices, such as one or more of the systems or devices in FIG. 1. One or more processors of a computer system may be included in a single computing device or distributed among a plurality of computing devices. A memory of the computer system may include the respective memory of each computing device of the plurality of computing devices.

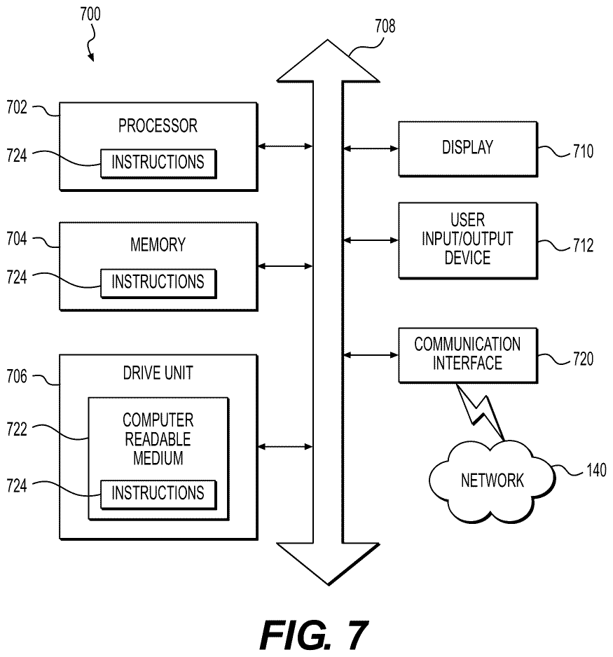

FIG. 7 is a simplified functional block diagram of a computer 700 that may be configured as a device for executing any of the processes, operations, or methods of FIGS. 2A-6, according to exemplary embodiments of the present disclosure. For example, the computer 700 may be configured as the organization computing system 102 or the entity system 130, according to exemplary embodiments of this disclosure. In various embodiments, any of the devices or systems herein may be a computer 700 including, for example, a data communication interface 720 for packet data communication. The computer 700 also may include a central processing unit (“CPU”) 702, in the form of one or more processors, for executing program instructions. The computer 700 may include an internal communication bus 708, and a storage unit 706 (such as ROM, HDD, SDD, etc.) that may store data on a computer readable medium 722, although the computer 700 may receive programming and data via network communications. The computer 700 may also have a memory 704 (such as RAM) storing instructions 724 for executing techniques presented herein, although the instructions 724 may be stored temporarily or permanently within other modules of computer 700 (e.g., processor 702 or computer readable medium 722). The computer 700 also may include input and output ports 712 or a display (or display screen) 710 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to transmitting data, it should be appreciated that the disclosed embodiments may be applicable to any environment, such as a desktop or laptop computer, etc. Also, the disclosed embodiments may be applicable to any type of Internet protocol.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A method comprising:
determining, using a first sub-model of a first machine learning model of a machine learning system, one or more internal requirements based on one or more external requirements;
generating, using a second sub-model of the first machine learning model, first information representing one or more differences between the one or more internal requirements and one or more previous internal requirements;
generating, using a second machine learning model of the machine learning system, second information representing updates to be made to first code based on the first code and the one or more internal requirements;
generating, using a third machine learning model of the machine learning system, third information based on existing data and the one or more internal requirements, the third information representing, for one or more terms of the one or more internal requirements, an association between each of the one or more terms and a respective dataset, the respective dataset including at least one of a portion of the existing data or an identification of new data; and
generating, using a fourth machine learning model of the machine learning system, updated first code based on the first information, the second information, and the third information.

2. The method of claim 1, wherein the updated first code is generated, using the fourth machine learning model of the machine learning system, further based on the new data.

3. The method of claim 1, further comprising:
generating fourth information based on the updated first code.

4. The method of claim 3, further comprising:
receiving, by the machine learning system, fifth information representing feedback associated with a test for validation of the fourth information.

5. The method of claim 1, wherein the existing data is standardized.

6. The method of claim 1, wherein the existing data includes metadata.

7. The method of claim 1, wherein the first information is generated, using the second sub-model of the first machine learning model, based on comparing the one or more internal requirements to the one or more previous internal requirements, and wherein the first information represents text data.

8. The method of claim 3, further comprising:
classifying, using the machine learning system, information as relevant to generating one or more of the updated first code or the fourth information, wherein one or more of the updated first code or the fourth information is generated based on the classified information;
outputting, using the machine learning system, recommended information, wherein the recommended information represents information needed to generate one or more of the updated first code or the fourth information; or
transmitting, by the machine learning system and to a storage component, an indication of missing information, wherein the missing information represents information missing from the machine learning system and needed to generate one or more of the updated first code or the fourth information.

9. The method of claim 1, wherein one or more of the first machine learning model, the second machine learning model, the third machine learning model, or the fourth machine learning model, includes a respective generative machine learning model.

10. A computing system, comprising:
a processor; and
a memory having programming instructions stored thereon, which, when executed by the processor, cause the computing system to perform operations comprising:
determining, using a first sub-model of a first large language model (LLM) agent of an artificial intelligence system, one or more internal requirements based on one or more external requirements;
generating, using a second sub-model of the first LLM agent, first information representing one or more differences between the one or more internal requirements and one or more previous internal requirements;
generating, using a second LLM agent of the artificial intelligence system, second information representing updates to be made to first code based on the first code and the one or more internal requirements;
generating, using a third LLM agent of the artificial intelligence system, third information based on existing data and the one or more internal requirements, the third information representing, for one or more terms of the one or more internal requirements, an association between each of the one or more terms and a respective dataset, the respective dataset including at least one of a portion of the existing data or an identification of new data; and
generating, using a fourth LLM agent of the artificial intelligence system, updated first code based on the first information, the second information, and the third information.

11. The computing system of claim 10, wherein the updated first code is generated, using the fourth LLM agent of the artificial intelligence system, further based on the new data.

12. The computing system of claim 10, wherein the operations further comprise:
generating fourth information based on the updated first code.

13. The computing system of claim 12, wherein the operations further comprise:
receiving, by the artificial intelligence system, fifth information representing feedback associated with a test for validation of the fourth information.

14. The computing system of claim 10, wherein the existing data is standardized.

15. The computing system of claim 10, wherein the existing data includes metadata.

16. The computing system of claim 10, wherein the first information is generated, using the second sub-model of the first LLM agent, based on comparing the one or more internal requirements to the one or more previous internal requirements, and wherein the first information represents text data.

17. The computing system of claim 10, wherein the operations further comprise:
classifying, using the artificial intelligence system, information as relevant to generating one or more of the updated first code or the fourth information, wherein one or more of the updated first code or the fourth information is generated based on the classified information;
outputting, using the artificial intelligence system, recommended information, wherein the recommended information represents information needed to generate one or more of the updated first code or the fourth information; or
transmitting, by the artificial intelligence system and to a storage component, an indication of missing information, wherein the indication of missing information represents information missing from the artificial intelligence system and needed to generate one or more of the updated first code or the fourth information.

18. The computing system of claim 10, wherein one or more of the first LLM agent, the second LLM agent, the third LLM agent, or the fourth LLM agent, includes a respective generative machine learning model.

19. A method comprising:
determining, using a first sub-model of a first machine learning model, one or more internal requirements based on one or more external requirements;
generating, using a second sub-model of the first machine learning model, first information representing one or more differences between the one or more internal requirements and one or more previous internal requirements;
generating, using a second machine learning model, second information representing updates to be made to first code based on the first code and the one or more internal requirements;
generating, using a third machine learning model, third information based on existing data and the one or more internal requirements, the third information representing, for one or more terms of the one or more internal requirements, an association between each of the one or more terms and a respective dataset, the respective dataset including at least one of a portion of the existing data or an identification of new data; and
generating, using a fourth machine learning model, updated first code based on the first information, the second information, and the third information.

20. The method of claim 19, wherein the updated first code is generated, using the fourth machine learning model, further based on the new data.
